(19) United States
(12) Patent Application Publication
(10) Pub. No.: US 2018/0065852 A1
(43) Pub. Date: Mar. 8, 2018

(54) METHOD FOR PREPARING A SPHERICAL ALN GRANULE

(71) Applicant: NATIONAL CHUNG SHAN INSTITUTE OF SCIENCE AND TECHNOLOGY, Taoyuan City (TW)

(72) Inventors: KUAN-TING LAI, TAOYUAN CITY (TW); CHI-SHIUNG HSI, Miaoli County (TW); MIN-YU YANG, Miaoli County (TW)

(21) Appl. No.: 15/258,707

(22) Filed: Sep. 7, 2016

(51) Int. Cl. C01B 21/072

(52) U.S. Cl. CPC C01B 21/0726; C01P 2004/32

(57) ABSTRACT

A method for preparing a spherical aluminum nitride granule includes (A) providing an aluminum oxide powder and a resin, followed by dissolving the aluminum oxide powder and the resin in a solvent to form a mixed slurry; (B) performing spray drying on the mixed slurry to form a spherical granule; (C) performing carbonization on the spherical granule in an inert atmosphere to form a carbonized spherical granule; (D) performing carbothermic reduction on the carbonized spherical granule in a nitrogen atmosphere to form a spherical aluminum nitride granule; (E) performing a densification sintering thermal treatment continuously on the spherical aluminum nitride granule in a nitrogen atmosphere; and (F) performing decarbonization on the densified spherical aluminum nitride granule in a nitrogen atmosphere to form densified spherical aluminum nitride sintered particles of tens of micrometers. Accordingly, the manufacturing process is simple and energy-saving.

### FIELD OF THE INVENTION

The present invention relates to methods for preparing aluminum nitride granules and, more particularly, to a method for preparing a spherical aluminum nitride granule.

### BACKGROUND OF THE INVENTION

Aluminum nitride exhibits high bonding strength, high lattice levels and oscillation, as well as high heat conductivity which theoretically reaches 320 W/m·K. Furthermore, it approximates to silicon in terms of thermal expansion rate. Hence, electronic substrates are best made from aluminum nitride powders.

Fillers of high heat conductivity play an important role in increasing the heat conductivity of heat-dissipating materials. For example, silicone rubber exhibits tolerance to high temperature and low temperature, resistance to ageing, and excellent electrical performance and thus is widely applied to heat-dissipating materials for use in aeronautics and electronics. Conventional silicone rubber-containing heat-dissipating materials are filled with fillers, such as aluminum nitride and boron nitride, to enhance the heat conductivity of silicone rubber. In this regard, due to its high heat conductivity and electrical insulation, microscale spherical aluminum nitride granules are desirable fillers for use with heat-dissipating materials applicable to heat sinks, adhesive agents, and paints. Spherical aluminum nitride granules have a particle diameter of 10˜100 μm, exhibit high fluidity and high mechanical strength, and thus are suitable for serving as a heat-dissipating filler for filling resin.

Aluminum nitride powders are synthesized by chemical vapor deposition, organometallic precursor, direct nitridation, carbothermic reduction and combustion synthesis. Among the aforesaid synthetic techniques, carbothermic reduction is the commonest, because it produces aluminum nitride powders of high purity, small particle diameter, and stable performance by a simple manufacturing process.

According to the prior art, carbothermic reduction entails mixing solid carbon black and aluminum oxide powders. Since aluminum nitride powders must be synthesized at a high temperature (>1700° C.), controlling the uniformity of the mixing of carbon black and aluminum oxide powders is never easy. Moreover, carbothermic reduction requires a high carbon black mixing ratio; however, the high carbon content takes time to attain in the course of decarbonization, thereby leading to an increase in the oxygen content of aluminum nitride powders and a decrease in the purity thereof. The preparation of spherical aluminum nitride granules by carbothermic reduction is disclosed in the prior art. For example, China patent 103079996 discloses mixing aluminum oxide, rare earth metals (Y, La) or alkaline earth metallic compounds, and carbon powder and then the mixture undergoes nitridation at 1620˜1900° C. to produce spherical aluminum nitride particles. However, the aforesaid reaction takes time as much as 10˜20 hours, tends to produce strip-like products, and is difficult to control.

To prepare spherical aluminum nitride particles of tens of micrometers, it is necessary to mix microscale or sub-microscale aluminum nitride powders and additives to produce a slurry which then undergoes spray particle-forming, high-temperature calcination, and ball milling to produce spherical aluminum nitride particles. China patent 101525238 discloses mixing aluminum nitride powders and sphericalized deoxygenized auxiliary materials by ball milling, keeping the mixture in a nitrogen gas or argon environment at 1550˜1900° C. for 0˜20 hours, and allowing the heated mixture to undergo acid-rinsing, water-rinsing, and drying, so as to produce spherical aluminum nitride granules with oxygen content of less than 1 wt %. China patent 103588182 discloses mixing spherical aluminum powder, aluminum nitride powder, and ammonium chloride powders by ball milling, and then allowing the mixed powders to undergo combustion and synthesis in a porous graphite crucible to produce whitish gray spherical aluminum nitride granules. China patent 104909762 discloses mixing aluminum nitride powders with particle diameters of 0.5˜5 μm, a binder, a sintering-enhancing agent, and a dispersing agent in an organic solvent by ball milling for 12 hours to form a slurry, performing a spray particle-forming process on the slurry to produce spherical aluminum nitride granules, performing calcination on the spherical aluminum nitride granules in the presence of nitrogen gas at a high temperature of 1450˜1850° C. for 0.5˜2 hours, and allowing the calcined granules to be mixed by ball milling in an alcohol, dispersed, and dried to produce dried spherical aluminum nitride granules. U.S. published patent application 20140042675 discloses mixing aluminum nitride powders in an organic solvent by ball milling for 1 hour to form aluminum nitride powders with particle diameters of 2˜3 μm, adding an PVB binder, a sintering-enhancing agent, and a dispersing agent to an aluminum nitride alcohol solution to mix them for 22 hours until they forming a slurry, and allowing the slurry to undergo a spray particle-forming process until it forms spherical aluminum nitride granules with an average particle diameter of 110.7 μm. The method for preparing a spherical aluminum nitride has disadvantages as follows: its raw material is aluminum nitride granules which are expensive to the detriment of cost control, and its reaction takes much time, thereby failing to be put into mass production.

Accordingly, it is important to provide a method for preparing a spherical aluminum nitride granule, using low-cost aluminum oxide and carbon-containing materials as raw materials, and carrying out a simple manufacturing process, with a view to preparing spherical aluminum nitride granules of tens of micrometers. Furthermore, the method for preparing a spherical aluminum nitride granule involves carrying out a sintering heat treatment to further enhance the densification of aluminum nitride granules, so as to directly prepare a spherical aluminum nitride granule which is up to industrial standard.

### SUMMARY OF THE INVENTION

In view of the aforesaid drawbacks of the prior art, it is an objective of the present invention to provide a method for preparing a spherical aluminum nitride granules, comprising the steps of mixing raw materials, spray drying, carbonization, carbothermic reduction, densification sintering thermal treatment, and decarbonization, so as to prepare spherical aluminum nitride granules of satisfactory characteristics.

The spray drying technique used in the present invention entails atomizing raw material-containing mixed slurry by high-speed rotation to produce dry spherical solid granules. The advantages of the spray drying technique used in the present invention include: a quick drying process, and keeping the particle diameter of spherical granules at 10˜80 μm. The carbothermic reduction and densification sintering thermal treatment of the present invention are effective in raising the operating temperature continuously in two steps to thereby directly produce densified spherical aluminum nitride sintered particles, and in consequence the spherical aluminum nitride particles thus produced are significantly improved in an economic sense.

In order to achieve the above and other objectives, the present invention provides a method for preparing a spherical aluminum nitride granule. The method comprises the steps of: (A) providing an aluminum oxide powder and a resin, followed by dissolving the aluminum oxide powder and the resin in a solvent to form a mixed slurry; (B) performing spray drying on the mixed slurry to form a spherical granule; (C) performing carbonization on the spherical granule in an inert atmosphere to form a carbonized spherical granule; (D) performing carbothermic reduction on the carbonized spherical granule in a nitrogen atmosphere to form a spherical aluminum nitride granule; (E) performing a densification sintering thermal treatment continuously on the spherical aluminum nitride granule in a nitrogen atmosphere; and (F) performing decarbonization on the densified spherical aluminum nitride granule in a nitrogen atmosphere to form a densified spherical aluminum nitride sintered particle.

In step (A), the crystal structure of the aluminum oxide powder is α-aluminum oxide phase, γ-aluminum oxide phase, δ-aluminum oxide phase, or a combination thereof. The resin is phenol resin, epoxy resin, formaldehyde urea resin, polymethylmethacrylate, polytetrafluoroethylene, or melamine-formaldehyde resin. The solvent is water, methanol, ethanol, isopropanol, n-butanol, or acetone aqueous solution. The raw materials are mixed by stirring or ball milling.

In step (C), the carbonization takes place at 700° C.˜900° C. In step (D), the carbothermic reduction takes place at 1500° C.˜1700° C., and the nitrogen atmosphere is pure nitrogen gas, a mixture of nitrogen gas and hydrogen gas, or a mixture of nitrogen gas and ammonia gas. In step (E), the sintering temperature is 1750° C.˜1850° C., and the nitrogen atmosphere is pure nitrogen gas, a mixture of nitrogen gas and hydrogen gas, or a mixture of nitrogen gas and ammonia gas.

The present invention is directed to a method for preparing a spherical aluminum nitride granule. The method is characterized in that: carbon-containing resin and aluminum oxide powders undergo spray drying to produce spherical uniformly-mixed granules of tens of micrometers; the spherical granules each have a large specific surface area; the resin appears in the form of a thin resin layer on the surfaces of the aluminum oxide powders; when carbonized, the thin resin layer forms high-activity porous substances so as to attain a much larger surface area of contact with aluminum oxide; it increases nitridation speed and decreases carbon consumption in the course of carbothermic reduction; hence, it brings plenty economic benefits. The related manufacturing process involves raising temperature in two steps to enable the carbothermic reduction and densification sintering thermal treatment to continue, directly produce densified spherical aluminum nitride sintered particles of a high density and low specific surface area, simplify the manufacturing process, and achieve energy saving.

The aforesaid summary and the following detailed description and accompanying drawings are intended to further explain the predetermined objectives, means, and effects of the present invention. The other objectives and advantages of the present invention are illustrated with drawings and described hereunder.

### BRIEF DESCRIPTION OF THE DRAWINGS

FIG. 1 is a flowchart of a method for preparing a spherical aluminum nitride granule according to the present invention;

FIG. 2 is an SEM picture taken of spray-dried spherical granules according to an embodiment of the present invention;

FIG. 3 is an SEM picture taken of carbonized spherical granules according to an embodiment of the present invention;

FIG. 4 is an SEM picture taken of spherical aluminum nitride granules which have undergone carbothermic reduction according to an embodiment of the present invention;

FIG. 5 are graphs of spherical aluminum nitride granules which have undergone carbothermic reduction and imaged by X-ray according to an embodiment of the present invention; and

FIG. 6 are SEM pictures taken of densified spherical aluminum nitride sintered particles according to an embodiment of the present invention.

### DETAILED DESCRIPTION OF THE PREFERRED EMBODIMENTS

The implementation of the present invention is illustrated with specific embodiments. By making reference to the disclosure contained in the specification, persons skilled in the art can easily accomplish the advantages and effects of the present invention.

A method for preparing a spherical aluminum nitride granule according to the present invention involves covering uniformly the surfaces of aluminum oxide powders with a carbon-containing resin by spray drying, performing primary carbonization on the granules, mixing the carbonized granules uniformly, allowing the mixed carbonized granules to undergo carbothermic reduction at 1500° C.˜1700° C. so as to form a spherical aluminum nitride granule, allowing the granule to undergo a densification sintering thermal treatment at a high temperature of 1750° C.˜1850° C., and allowing the sintered granule to undergo decarbonization in an oxygen-containing environment, thereby preparing densified spherical aluminum nitride sintered particles. During the carbothermic reduction, the resin, which covers aluminum oxide powder surfaces and is carbonized, functions as a reducing agent for reducing aluminum oxide in a nitrogen atmosphere, and thus the products of reduction, namely aluminum and nitrogen gas, react to produce aluminum nitride granules. Furthermore, the method for preparing a spherical aluminum nitride granule according to the present invention includes a sintering heat treatment which enhances the densification of the aluminum nitride granules but reduces the specific surface area thereof, thereby preparing densified spherical aluminum nitride particles.

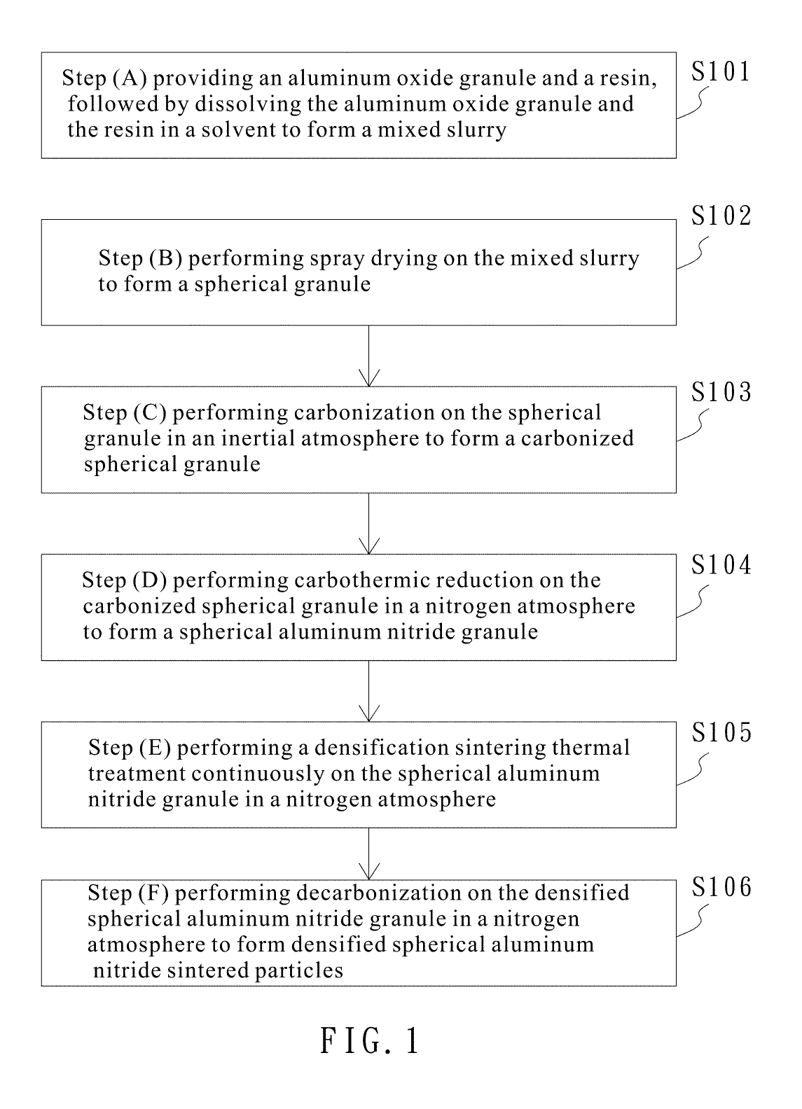

Referring to FIG. 1, there is shown a flowchart of a method for preparing a spherical aluminum nitride granule according to the present invention. As shown in the diagram, the present invention provides a method for preparing a spherical aluminum nitride granule, comprises the steps of: (A) providing an aluminum oxide powder and a resin, followed by dissolving the aluminum oxide powder and the resin in a solvent to form a mixed slurry (S101); (B) performing spray drying on the mixed slurry to form a spherical granule (S102); (C) performing carbonization on the spherical granule in an inert atmosphere to form a carbonized spherical granule (S103); (D) performing carbothermic reduction on the carbonized spherical granule in a nitrogen atmosphere to form a spherical aluminum nitride granule (S104); (E) performing a densification sintering thermal treatment continuously on the spherical aluminum nitride granule in a nitrogen atmosphere (S105); and (F) performing in a nitrogen atmosphere decarbonization on the spherical aluminum nitride granule which has undergone the densification sintering thermal treatment to form a densified spherical aluminum nitride sintered particles (S106).

The crystal structure of the aluminum oxide powder is α-aluminum oxide phase, γ-aluminum oxide phase, δ-aluminum oxide phase, or a combination thereof. The resin is phenol resin, epoxy resin, formaldehyde urea resin, polymethylmethacrylate, polytetrafluoroethylene, melamine-formaldehyde resin. The solvent is water, methanol, ethanol, isopropanol, n-butanol, or acetone aqueous solution. Regarding mixing raw materials, the weight ratio of the aluminum oxide powder to the resin is 1:0.5˜2.0. The raw materials are mixed by stirring or ball milling.

### Embodiment 1

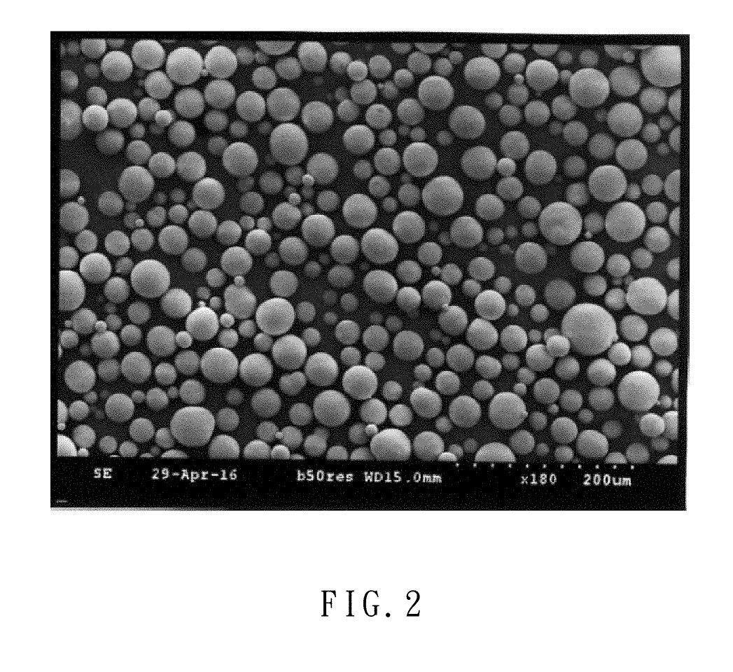

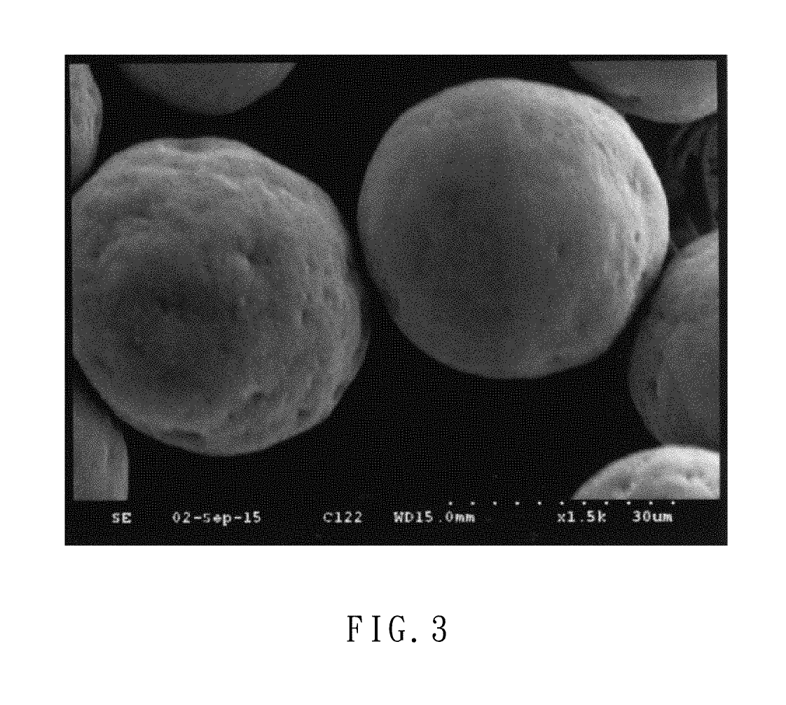

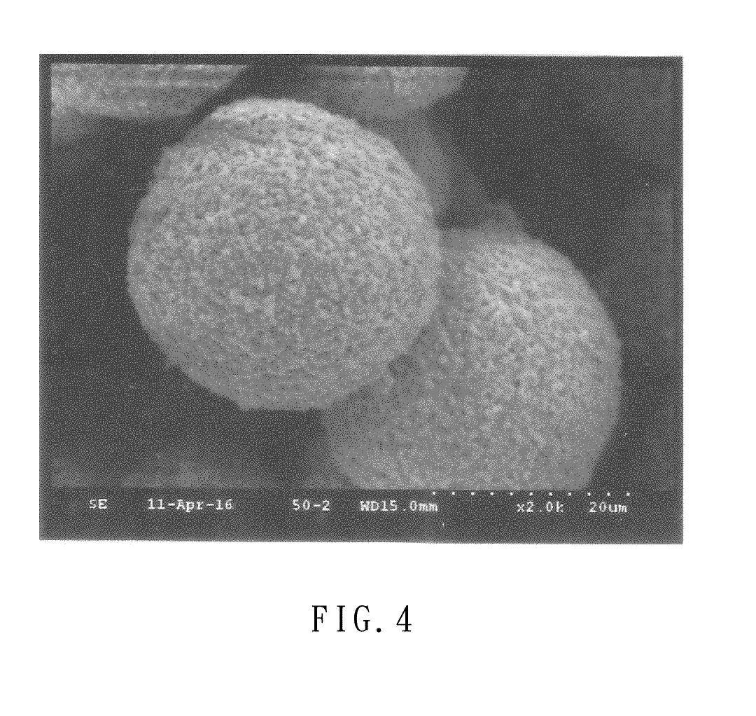

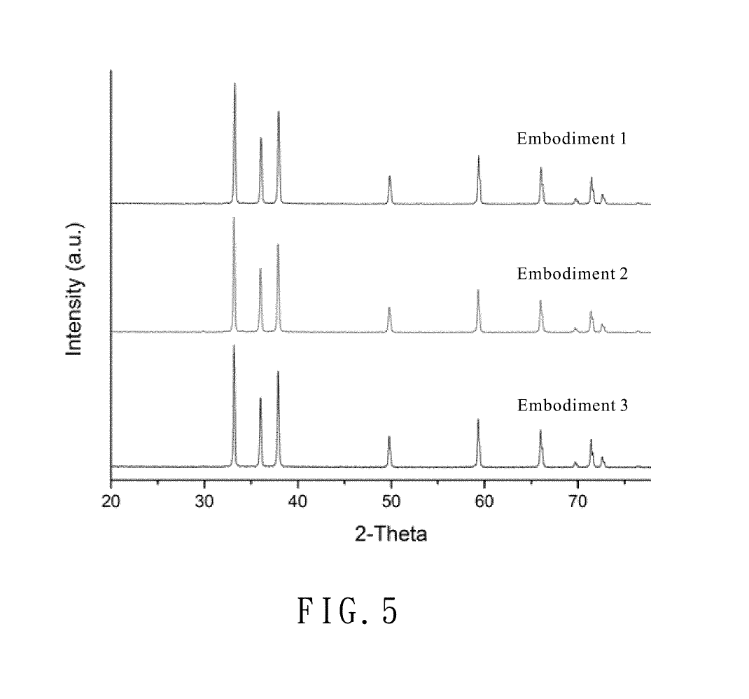

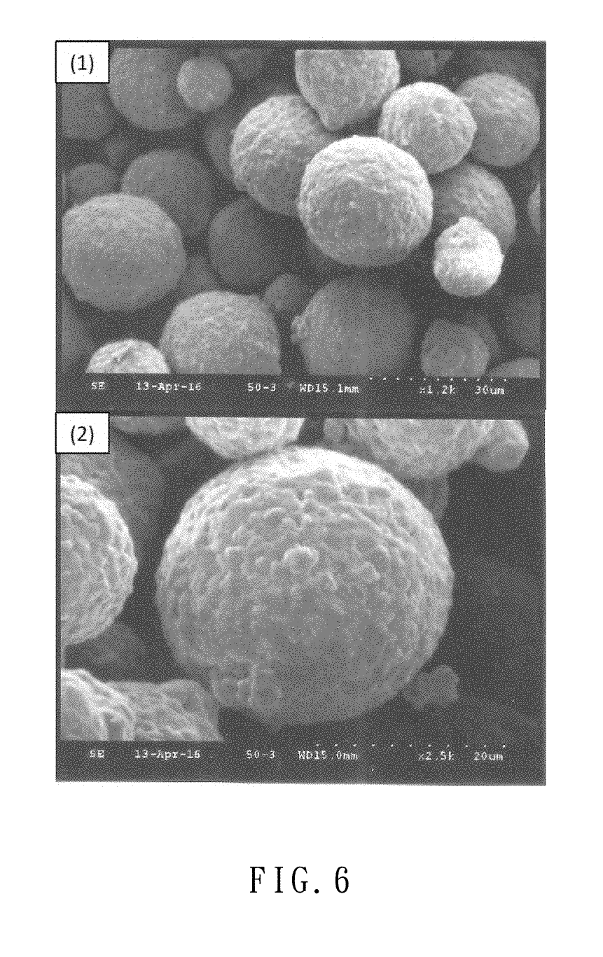

100 g of aluminum oxide powders are placed in 1000 mL of ethanol to form a disperse solution. 50 g of phenol resin is dissolved in 1000 mL of ethanol to form a resin solution. Then, the two aforesaid solutions are uniformly mixed to form mixed slurry. Afterward, the mixed slurry undergoes spray drying with an atomizer at a rotation speed of 10000 rpm to form spherical granules. Referring to FIG. 2, there is shown an SEM picture taken of spray-dried spherical granules according to an embodiment of the present invention. As shown in the diagram, the powders undergo spray drying to become spherical granules of tens of micrometers, that is, an average particle diameter D₅₀ of 40.74 μm, as measured with a laser particle diameter analyzer. Afterward, the spherical granules thus produced are placed in a boron nitride crucible (BN crucible), and then the spherical granules undergo carbonization in a high-temperature furnace with a nitrogen gas atmosphere at 800° C. for 1 hour to form carbonized spherical granule. Referring to FIG. 3, there is shown an SEM picture taken of carbonized spherical granules according to an embodiment of the present invention. The carbonized spherical granules are heated to raise its temperature at a speed of 5° C./min and eventually stays at 1600° C. for 7 hours; afterward, the carbonized spherical granules undergo carbothermic reduction in a high-temperature furnace with a nitrogen gas or nitrogen-hydrogen mixture atmosphere to form a spherical aluminum nitride granule. Referring to FIG. 4, there is shown an SEM picture taken of spherical aluminum nitride granules which have undergone carbothermic reduction according to an embodiment of the present invention. As shown in the diagram, after undergoing carbothermic reduction, the granules look spherical. Referring to FIG. 5, there are shown graphs of spherical aluminum nitride granules which have undergone carbothermic reduction with an aluminum oxide to phenol resin weight ratio of 1:0.5 and imaged by X-ray according to an embodiment of the present invention. As shown in the diagram, the granules thus prepared manifest a single pure phase of aluminum nitride, thereby confirming that the preparation of a spherical aluminum nitride granule is done. Afterward, the spherical aluminum nitride granules undergo a densification sintering thermal treatment in a high-temperature furnace at 1850° C. for 5 hours. Eventually, the densified spherical aluminum nitride granules undergo decarbonization in the air at 650° C. for 10 hours to produce densified spherical aluminum nitride sintered particles. Referring to FIG. 6, there are shown SEM pictures taken of densified spherical aluminum nitride sintered particles according to an embodiment of the present invention. As shown in the diagrams, after undergoing decarbonization, the spherical aluminum nitride particles look uniformly spherical. The granules have an average particle diameter D₅₀ of 29.74 μm and sphericality D_{S}/D_{L} (short diameter to long diameter ratio) greater than 0.85. Furthermore, the Brunauer-Emmett-Teller (BET) specific surface area of the granules is evaluated by gas adsorption technique and determined to be 0.16 m²/g, showing that the densified spherical aluminum nitride sintered particles are already satisfactorily prepared.

### Embodiment 2

100 g of aluminum oxide powders are placed in 1000 mL of ethanol to form a disperse solution. 60 g of phenol resin is dissolved in 1000 mL of ethanol to form a resin solution. Afterward, the two aforesaid solutions are uniformly mixed to form mixed slurry. Afterward, the mixed slurry undergoes spray drying with an atomizer at a rotation speed of 10000 rpm to form spherical granules with an average particle diameter D₅₀ of 39.54 μm, as measured with a laser particle diameter analyzer. Afterward, the spherical granules thus produced are placed in a boron nitride crucible (BN crucible), and then the spherical granules undergo carbonization in a high-temperature furnace with nitrogen gas atmosphere at 800° C. for 2 hours to form carbonized spherical granules. The carbonized spherical granules are heated to raise its temperature at a speed of 5° C./min and eventually stays at 1600° C. for 7 hours; afterward, the carbonized spherical granules undergo carbothermic reduction in a high-temperature furnace with a nitrogen gas or nitrogen-hydrogen mixture atmosphere to form a spherical aluminum nitride granule. Referring to FIG. 5, there are shown graphs of spherical aluminum nitride granules which have undergone carbothermic reduction and imaged by X-ray according to an embodiment of the present invention. In embodiment 2, the aluminum oxide to phenol resin weight ratio is 1:0.6. As shown in the diagram, the granules thus prepared manifest a single pure phase of aluminum nitride, thereby confirming that the preparation of a spherical aluminum nitride granule is done. Afterward, the spherical aluminum nitride granules undergo a densification sintering thermal treatment in a high-temperature furnace at 1830° C. for 7 hours. Eventually, the densified spherical aluminum nitride granules undergo decarbonization in the air at 580° C. for 5 hours to produce densified spherical aluminum nitride sintered particles. The average particle diameter D₅₀ of the granules is assessed with a laser particle diameter analyzer and determined to be 28.25 μm, and sphericality D_{S}/D_{L} (short diameter to long diameter ratio) of the granules is found to be greater than 0.85. Furthermore, the BET specific surface area of the granules is evaluated by gas adsorption technique and determined to be 0.19 m²/g, showing that the densified spherical aluminum nitride sintered particles are already satisfactorily prepared.

### Embodiment 3

100 g of aluminum oxide powders are placed in 1000 mL of ethanol to form a disperse solution. 70 g of phenol resin is dissolved in 1000 mL of ethanol to form a resin solution. Afterward, the two aforesaid solutions are uniformly mixed to form mixed slurry. Afterward, the mixed slurry undergoes spray drying with an atomizer at a rotation speed of 12000 rpm to form spherical granules with an average particle diameter D₅₀ of 37.24 μm, as measured with a laser particle diameter analyzer. Afterward, the spherical granules thus produced are placed in a boron nitride crucible (BN crucible), and then the spherical granules undergo carbonization in a high-temperature furnace with nitrogen gas atmosphere at 800° C. for 4 hours to form carbonized spherical granules. The carbonized spherical granules are heated to raise its temperature at a speed of 5° C./min and eventually stays at 1600° C. for 7 hours; afterward, the carbonized spherical granules undergo carbothermic reduction in a high-temperature furnace with a nitrogen gas or nitrogen-hydrogen mixture atmosphere to form a spherical aluminum nitride granule. Referring to FIG. 5, there are shown graphs of spherical aluminum nitride granules which have undergone carbothermic reduction and imaged by X-ray according to an embodiment of the present invention. In embodiment 3, the aluminum oxide to phenol resin weight ratio is 1:0.7. As shown in the diagram, the granules thus prepared manifest a single pure phase of aluminum nitride, thereby confirming that the preparation of a spherical aluminum nitride granule is done. Afterward, the spherical aluminum nitride granules undergo a densification sintering thermal treatment in a high-temperature furnace at 1800° C. for 10 hours. Eventually, the densified spherical aluminum nitride granules undergo decarbonization in the air at 580° C. for 3 hours to produce densified spherical aluminum nitride sintered particles. The average particle diameter D₅₀ of the granules is assessed with a laser particle diameter analyzer and determined to be 27.68 μm, and sphericality D_{S}/D_{L} (short diameter to long diameter ratio) of the granules is found to be greater than 0.85. Furthermore, the BET specific surface area of the granules is evaluated by gas adsorption technique and determined to be 0.23 m²/g, showing that the densified spherical aluminum nitride sintered particles are already satisfactorily prepared.

Unlike conventional carbothermic reduction, the method of the present invention is characterized in that: carbon-containing resin substitutes for carbon black systems such that aluminum nitride granules in a pure phase can be synthesized at 1600° C.; it dispenses with an additional slurry adjusting step and process environment; given a temperature-raising process, densified spherical aluminum nitride particles of a high density but low surface area are prepared. Hence, the method of the present invention features a simple process flow, incurs low production costs, dispenses with extra additives, and reduces consumption of carbon-containing raw materials greatly. The method of the present invention is further characterized in that aluminum oxide powder surfaces are uniformly covered with the carbon-containing resin by spray drying, and the powders are uniformly mixed as a result of primary carbonization, so as to greatly lower the carbothermic reduction temperature, thereby bring economic benefits, effectuating energy saving, and opening up to wide applications.

Although the present invention is disclosed above by embodiments, the embodiments are not restrictive of the present invention. Any persons skilled in the art can make some changes and modifications to the embodiments without departing from the spirit and scope of the present invention. Accordingly, the legal protection for the present invention should be defined by the appended claims.

What is claimed is:

1. A method for preparing a spherical aluminum nitride granule, comprising the steps of:
(A) providing an aluminum oxide powder and a resin, followed by dissolving the aluminum oxide powder and the resin in a solvent to form a mixed slurry;
(B) performing spray drying on the mixed slurry to form a spherical granule;
(C) performing carbonization on the spherical granule in an inert atmosphere to form a carbonized spherical granule;
(D) performing carbothermic reduction on the carbonized spherical granule in a nitrogen atmosphere to form a spherical aluminum nitride granule;
(E) performing a densification sintering thermal treatment continuously on the spherical aluminum nitride granule in a nitrogen atmosphere; and
(F) performing in a nitrogen atmosphere decarbonization on the spherical aluminum nitride granule which has undergone the densification sintering thermal treatment;
wherein a weight ratio of the aluminum oxide powder to the resin is 1:0.5˜2.0;
wherein the carbothermic reduction in the step (D) is performed at 1500° C.˜1600° C.;
wherein a sintering temperature of the step (E) is 1750° C.˜1850° C.

2. The method for preparing a spherical aluminum nitride granule according to claim 1, wherein a crystal structure of the aluminum oxide powder comprises one selected from the group consisting of α-aluminum oxide phase, γ-aluminum oxide phase, δ-aluminum oxide phase, and a combination thereof.

3. The method for preparing a spherical aluminum nitride granule according to claim 1, wherein the resin is one of phenol resin, epoxy resin, formaldehyde urea resin, polymethylmethacrylate, polytetrafluoroethylene, and melamine-formaldehyde resin.

4. The method for preparing a spherical aluminum nitride granule according to claim 1, wherein the solvent is one of water, methanol, ethanol, isopropanol, n-butanol, and acetone aqueous solution.

5. (canceled)

6. The method for preparing a spherical aluminum nitride granule according to claim 1, wherein, the step (A) entails one of stirring and ball milling.

7. The method for preparing a spherical aluminum nitride granule according to claim 1, wherein, the carbonization in the step (C) is performed at 700° C.˜900° C.

8. (canceled)

9. (canceled)

10. The method for preparing a spherical aluminum nitride granule according to claim 1, wherein the nitrogen atmosphere of the step (D) and step (E) is one of pure nitrogen gas, a mixture of nitrogen gas and hydrogen gas, and a mixture of nitrogen gas and ammonia gas.
